(19) United States
(12) Patent Application Publication
(10) Pub. No.: US 2006/0187782 A1
(43) Pub. Date: Aug. 24, 2006

(54) Information recording medium, recording/reproducing apparatus, and recording/reproducing method

(75) Inventors: Sung-hee Hwang, Suwon-si (KR); Jung-wan Ko, Suwon-si (KR); Kyung-geun Lee, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/338,839

(22) Filed: Jan. 25, 2006

(30) Foreign Application Priority Data
Feb. 18, 2005 (KR) 2005-13520

(51) Int. Cl. G11B 7/00

(52) U.S. Cl. 369/47.14; 369/53.17; 369/53.24

(57) ABSTRACT

An information recording medium is provided with a linking loss area having a unit smaller than a unit of block and having a predetermined size is disposed in a recording block used for the replacement by logical overwrite (LOW) or the replacement by defect so as to update data recorded thereon. As a result, the loss of user data capacity which can be practically used for a linking action due to replacement by defect or LOW (Logical Overwrite)-based replacement can be minimized.

### CROSS-REFERENCE TO RELATED APPLICATIONS

This application claims all benefits accruing under 35 U.S.C. §119 from Korean Patent Application No. 2005-13520, filed on Feb. 18, 2005, in the Korean Intellectual Property Office, the disclosure of which is incorporated by reference herein.

### BACKGROUND OF THE INVENTION

1. Field of the Invention

The present invention relates to an information recording medium, such as an optical disk, and more particularly, relates to a recording/reproducing apparatus, and a recording/reproducing method, in which a linking action can be effectively performed through a new recording action for replacement by a drive system including logical overwrite (LOW)-based replacement or replacement by defect.

2. Related Art

The unit of record/reproduction for recording/reproducing data on an information storage medium in drive systems and the unit of record/reproduction unit for recording/reproducing data in file systems or application programs are often different from each other. For example, the unit of record/reproduction used in the file systems or application programs is mainly 1 sector (2048 bytes). In contrast, the unit of record/reproduction used in the drive systems is mainly a block including a plurality of sectors, typically 16 sectors (16*2048 bytes) or 32 sectors (32*2048 bytes).

Furthermore, if an information storage medium is a non-rewritable information storage medium, data can be written thereon only once, and such data cannot be physically overwritten. However, such data can be logically overwritten. The “logical overwrite” (LOW) means that data to be overwritten by a linear replacement method of a drive system is written (recorded) on a non-recorded area of the medium and a recording state is expressed and managed as a replacement entry, when a data write command is issued from a host to an area of the medium in which data is already written or an area of the medium in which data is considered as being written. As a result, such a non-rewritable recording medium can be subjected to both logical overwrite-based replacement and replacement by defect, which will be described with reference to FIG. 1 herein below.

In a rewritable information recording medium, a spare area is generally provided in a data area to manage defects. That is, when a defect is detected during the course of recording user data in a user data area (an area in the data area that excludes the spare area) or reproducing user data recorded in the user data area, replacement data for replacing defect data is recorded in the spare area.

In the non-rewritable information recording medium, such a defect managing technique is used in connection with a logical overwrite (LOW). As previously described, the “logical overwrite” (LOW) is known as a method in which a rewritable recording medium can be used in the same manner as a non-rewritable information recording medium. That is, in order to update data already recorded in the user data area, recorded data is treated as if it is defective data, and data for replacing the recorded data is recorded in a non-recorded area. In this way, by fixing a logical address of the data recorded in the user data area and using a physical address corresponding to the logical address as an address of the replacement data, the host can be made to recognize that the data of the user data area is rewritten at the same position, thereby facilitating defect management. This is because the host is associated with only the logical address.

FIG. 1 is an explanatory diagram of an example data area on an information storage medium to illustrate data replacement by a logical overwrite (LOW) or by defect for defect management.

Referring to FIG. 1, a data area 100 includes a user data area 110 and at least one spare area 120. Data is typically recorded from a start address of the user data area 110. As shown in FIG. 1, when the host issues a write command to the drive system to access into original locations P1, P2, and P3 so as to update data blocks A1, A2, and A3 with B1, B2, and B3, respectively, based on the LOW in a state where the data blocks A1, A2, and A3 are recorded in physical spaces P1, P2, and P3 in the user data area 110 on the recording medium, the drive system updates data blocks B1, B2, and B3 at physical locations P4, P5, and P6 in the user data area 110 of the recording medium through the replacement by LOW, and generates a replacement entry indicating a state where the original locations P1, P2, and P3 have been replaced with replacement locations P4, P5, and P6, respectively.

Next, when the host issues a read command to the drive system to access the logical address corresponding to the original location in order to read the data B1, B2, and B3, the drive system reproduces data recorded in P4, P5, and P6 in the user data area 110 on the recording medium through the replacement entry and transmits the reproduced data to the host. The same method can be applied to the replacement by defect. However, replacement data in the case of the replacement by LOW is data obtained by updating the original data, while the replacement data in the case of the replacement by defect is data used for removing the defect of the original data.

The logical overwrite (LOW) can be performed only to the whole block or some sectors thereof. However, the replacement entry for the defect management of the conventional non-rewritable information recording medium or the logical overwrite (LOW) has a unit of replacement which is a block. That is, even when only some sectors within the block are subjected to the logical overwrite (LOW), the whole block including the sectors should be replaced and the state that the whole block is replaced is marked in the replacement entry.

On the other hand, when data is additionally recorded successive on the portion in which data has been written on an information recording medium such as DVD-R, a linking scheme is used to guarantee reliability of data. In the case of DVD-R, at the time of additionally writing data, a linking loss area of 2 KB or 32 KB (1 block) is applied by means of information exchange between a host and a drive system. When data is written successive to the portion in which data has been written, a linking area is filled with a value such as “00h”, and user data is written to the next sector.

In accordance with DVD-R standard, the drive system defines the linking loss area being applicable through mutual communication for the writing. When the linking loss area is defined, the host requests the drive system for a next writable address (NWA) in consideration of the linking loss area. At this time, the drive system reports to the host the NWA as an address of an area next to the area for the linking loss area at the end of the next writing area, and the host instructs the writing from the NWA. Then, the drive system fills the linking loss area previously defined with a value such as “00h”, and successively records the data transmitted from the host from the NWA. As a result, it is possible to prevent the damage on error correction ability for the portion in which data is linked and thus to guarantee the reliability of data.

An example of the linking scheme is now described with reference to FIG. 2. As shown in FIG. 2, the linking action should be performed between the 15^{th} byte and the 17^{th} byte of the first sync frame 220 of the first physical sector 210 in an ECC block 200. Such a sector 210 is referred to as a linking sector. The writing (recording) action using the linking scheme should be finished at the 16^{th} byte of the first sync frame 220 in the linking sector 210 and be started between the 15^{th} byte and the 17^{th} byte of the first sync frame 220 in the linking sector 210. The linking loss area is provided to prevent the decrease in data reliability due to the linking action.

That is, the writing (recording) through the linking action is not started at the start of a block, but is rather between the 15^{th} byte and the 17^{th} byte of the first sync frame of the block. Similarly, such a writing (recording) is not terminated at the end of the block, but is rather at the 16^{th} byte of the first sync frame in a next block. Therefore, since the first block in which data is newly written through the linking action includes data previously written (that is, the first 16^{th} byte of the first sync frame) and data which is error-corrected and encoded to record the corresponding block, the reliability of data is decreased at the time of error correction. Accordingly, by providing the linking loss area at the time of recording new data, any decrease of error correction can be prevented.

However, when the defect management or the logical overwrite is applied to the information storage medium employing the DVD-R or a linking scheme similar thereto, the linking action should be performed every time the replacement by the drive system such as the replacement by defect or the replacement by LOW is performed. Specifically, since the replacement is conventionally performed in a unit of block and the replacement entry also indicates the replacement in a unit of block, the linking loss area of at least 32 KB is required for the replacement. Accordingly, the loss of user data is increased due to the replacement. Since the linking loss area is required for the linking action, and thus the user data capacity which can be actually used is lost, new technique for minimizing the loss of user data capacity is required. In addition, since the drive system performs the replacement for itself, a linking scheme for the drive system is required.

That is, since the host performs the overwrite action to the same logical sector number (LSN) in the case of logical overwrite (LOW), the host does not require the concept of linking. In addition, since the host does not practically perform a new recording action, the host does not require the concept of linking. However, when the replacement equal or similar to the replacement by defect or the replacement by LOW is performed, data to be replaced should be written in a new area in which no data is written. Accordingly, the drive system requires a new linking scheme that minimizes the linking loss area and the user data capacity, while enhancing the reliability of data.

### SUMMARY OF THE INVENTION

Various aspects and example embodiments of the present invention provide an information recording medium, a recording/reproducing apparatus, and a recording/reproducing method, in which the loss in user data capacity can be prevented and data can be reproduced with high reliability in a linking action due to a new recording action for replacement by a drive system including replacement by LOW or replacement by defect.

Additional aspects and/or advantages of the invention will be set forth in part in the description which follows and, in part, will be obvious from the description, or may be learned by practice of the invention.

According to an aspect of the present invention, an information storage medium is provided with a linking loss area having a unit smaller than a unit of a recording block and having a predetermined size disposed in a recording block used for data replacement, for the purpose of replacement by logical overwrite (LOW) to update data recorded on the information storage medium or replacement by defects occurring on the information storage medium.

The unit that is smaller than a block may be a sector. The predetermined size may be N sectors, where N is an integer greater than zero (0) and smaller than sixteen (16). Information indicating the linking loss areas may be recorded in the recording block. Information indicating that a first sector of the recording block is the linking loss area may be recorded in the recording block or in a replacement entry containing information on the replacement.

When the information indicating the linking loss area is recorded in the recording block, the information may be written in a sector ID field of a second sector of the recording block.

In accordance with another aspect of the present invention, a recording apparatus for recording data in an information storage medium is provided with: a write/read unit which writes data in the information storage medium or reads data from the information storage medium; and a control unit which disposes a linking loss area having a unit smaller than a unit of a recording block and having a predetermined size in the recording block used for data replacement for the purpose of replacement by logical overwrite (LOW) to update data recorded on the information storage medium or replacement by defects occurring on the information storage medium, and which controls the write/read unit to write the recording block on the information storage medium.

In accordance with still another aspect of the present invention, a recording method of recording data in an information storage medium is provided with: disposing a linking loss area having a unit smaller than a unit of a recording block and having a predetermined size in the recording block used for data replacement for the purpose of replacement by logical overwrite (LOW) to update data recorded on the information storage medium or replacement by defects occurring on the information storage medium; and recording the recording block on the information storage medium.

In accordance with still another aspect of the present invention, a reproducing method for reproducing data from an information storage medium is provided with: reading from the information storage medium a recording block in which a linking loss area having a unit smaller than a unit of the recording block and having a predetermined size is disposed, wherein the recording block is recorded for data replacement for the purpose of replacement by logical overwrite (LOW) to update data recorded on the recording medium or replacement by defects occurring on the information storage medium; and reproducing the read recording block.

In addition to the example embodiments and aspects as described above, further aspects and embodiments of the present invention will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is an explanatory diagram of an example data area on an information storage medium to illustrate data replacement by a logical overwrite (LOW) or by defect for defect management;

FIG. 2 is an explanatory diagram illustrating a typical linking scheme;

FIG. 3 is a block diagram schematically illustrating an example recording/reproducing apparatus according to an embodiment of the present invention;

FIG. 4 is a detailed block diagram of the recording/reproducing apparatus shown in FIG. 3;

FIG. 5 shows an example structure of an information storage medium employing the linking scheme according to an embodiment of the present invention;

FIGS. 6A-6B are an explanatory diagram illustrating an example linking loss area for data replacement by LOW according to an embodiment of the present invention;

FIGS. 7A-7B are an explanatory diagram illustrating an example linking loss area for data replacement by LOW according to another embodiment of the present invention;

FIGS. 8A-8B are an explanatory diagram illustrating an example linking loss area for data replacement by LOW according to yet another embodiment of the present invention;

FIG. 9 is a diagram illustrating a structure of a sync frame for marking an example linking loss area according to an embodiment of the present invention;

FIG. 10 is an explanatory diagram illustrating an example linking loss area of 2*nKB according to an embodiment of the present invention;

FIG. 11 is an explanatory diagram illustrating an example linking loss area of 2 KB according to an embodiment of the present invention;

FIG. 12 is a diagram illustrating an example replacement entry according to an embodiment of the present invention;

FIG. 13 is a flowchart illustrating an example recording method according to an embodiment of the present invention; and

FIG. 14 is a flowchart illustrating an example reproducing method according to an embodiment of the present invention.

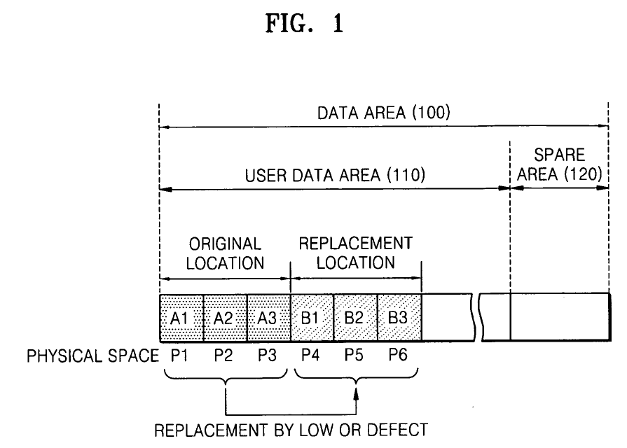

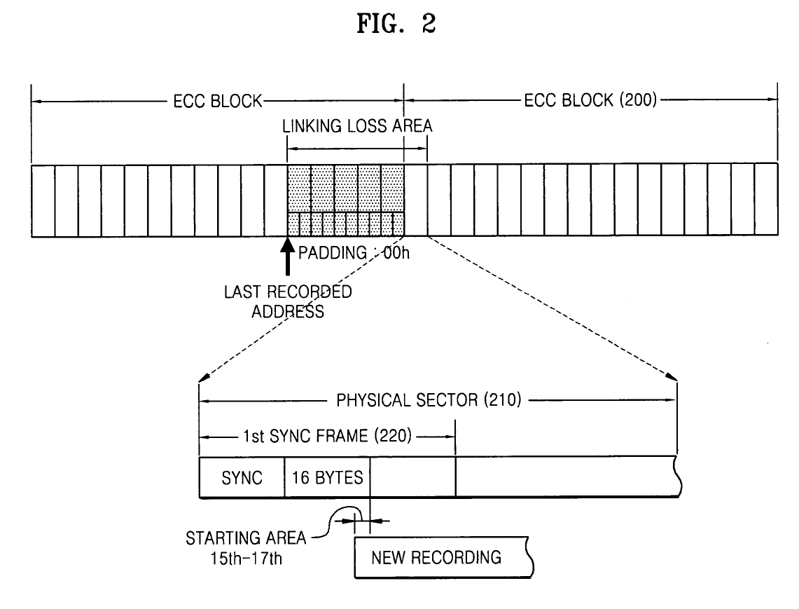

### DETAILED DESCRIPTION OF THE EMBODIMENTS

The present invention is applicable for use with all types of memory or computer-readable media, recording and/or reproducing apparatuses, and computer systems implemented methods described according to various embodiments of the present invention. However, for the sake of simplicity, discussions will concentrate mainly on exemplary use of a disk serving as a non-rewritable information storage medium, although the scope of the present invention is not limited thereto. Reference will now be made in detail to the present embodiments of the present invention, examples of which are illustrated in the accompanying drawings, wherein like reference numerals refer to the like elements throughout. The embodiments are described below in order to explain the present invention by referring to the figures.

FIG. 3 is a schematical block diagram of an example recording/reproducing apparatus according to an embodiment of the present invention.

Referring to FIG. 3, the recording/reproducing apparatus 300 can be a writable and/or reproducible apparatus, which includes a write/read unit 320 and a control unit 310. For purposes of brevity, the recording/reproducing apparatus 300, albeit in whole or in part, can also be referred to as a drive system which can be internal (housed within a host 340) or external (housed in a separate box that connects to the host 340).

The write/read unit 320 records data on a disk 500, which is an information storage medium according to the present embodiment, and reads data to reproduce the recorded data from the disk 500. The control unit 310 controls the write/read unit 320 to record data in blocks of predetermined recording units, or processes the data read by the write/read unit 320 to obtain effective data.

In a recording operation, the control unit 310 controls the write/read unit 320 to implement logical overwrite (LOW) in accordance with an instruction of a host or control of a drive system according to the present invention and to write data. Specifically, for the purpose of replacement based on the logical overwrite (LOW) or replacement based on defects to update data written in the disk 500, the control unit 310 controls the write/read unit 320 such that linking loss areas having a unit smaller than a unit of block and having a predetermined size are disposed in a recording block used for the replacement and the recording block is written in the disk 500. It is preferable that unit smaller than the unit of block is a sector. In addition, it is preferable that the control unit 310 records information for marking the linking loss areas in the recording block.

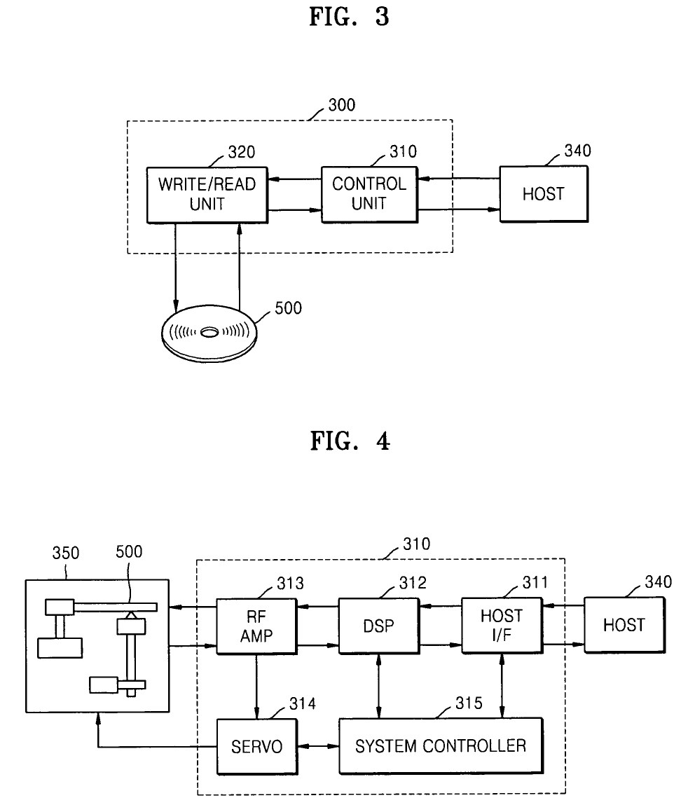

FIG. 4 is a detailed block diagram of an example recording/reproducing apparatus shown in FIG. 3.

Referring to FIG. 4, the control unit 310 and the write/read unit 320 can be implemented using several different components. For example, an optical pickup 350 may serve as the write/read unit 320 to perform recording/reproducing operations on the disk 500. The disk 500 may be mounted on the optical pickup 350. Similarly, a host interface (I/F) 311, a digital signal processor (DSP) 312, a radio frequency amplifier (RF AMP) 313, a servo 314, and a system controller 315 may serve as the control unit 310, as shown in FIG. 3.

In a recording operation, the host I/F 311 receives a write command from the host 340 along with data to be recorded and logical address information of the data to be recorded and transmits the same information to the system controller 315.

The system controller 315 receives the write command through the host I/F 311 and performs initialization for data recording.

Specifically, the system controller 315 according to a linking scheme of the present invention should perform the logical overwrite if the original sectors corresponding to the write command are sectors in which data has been already recorded. Accordingly, the system controller 315 generates a recording block including replacement sectors for replacing the original sectors. More specifically, a sector part for the linking loss area, a replacement sector part, and a padding sector part are disposed in the replacement recording block. Information indicating the linking loss area is further marked in the recording block and the information can be marked by using a data type bit of a sector ID in each sector.

The system controller 315 can record information indicating that the first sector of the recording block is the linking loss area in the recording block, or record information indicating that the first sector of the recording block is the linking loss area in a replacement entry containing information on the replacement. When the information indicating the linking loss area is recorded in the recording block, the information can be recorded by using a reserved bit of a sector ID field in the second sector of the recording block.

The DSP 312 adds additional data, such as parity or the like, so as to correct the data to be written input through the host I/F 311, performs ECC encoding, generates an ECC block as an error correcting block, and then modulates the ECC block in a predetermined manner. The RF AMP 213 converts the data output from the DSP 312 into an RF signal. The optical pickup 350 records the RF signal output from the RF AMP 313 on the disk 500. The servo 314 receives an instruction necessary for servo-control from the system controller 315 and servo-controls the optical pickup 350.

In a reproduction operation, the host I/F receives a read command from the host 340. The system controller 315 performs the initialization required for data reproduction.

Specifically, when receiving the read command for original sectors, the system controller 315 according to the present invention confirms replacement sectors from the replacement entry for the original sectors and controls the optical pickup 350 to reads a block including the replacement sectors from the disk 500. Then, the system controller 315 confirms the linking loss areas included in the block read from the disk 500 and controls the DSP 312 to consider the data recorded in the linking loss areas as “00h”, and correct errors of the read block. The system controller 315 controls the host I/F 311 to transmit the corrected data to the host 340.

The optical pickup 350 irradiates laser beams to the disk 500, receives the laser beams reflected from the disk 500, and then outputs an optical signal obtained from the laser beams reflected from the disk 500. The RF AMP 313 converts the optical signal output from the optical pickup 350 into an RF signal, supplies the modulated data obtained from the RF signal to the DSP 312, and supplies a servo signal for control obtained from the RF signal to the servo 314. The DSP 312 demodulates the modulated data and outputs the data obtained through the ECC error correction.

The servo 314 receives the servo signal from the RF AMP 313 and the instruction necessary for the servo control from the system controller 315, and performs the servo control of the optical pickup 350. The host I/F 311 transmits the data from the DSP 312 to the host 340.

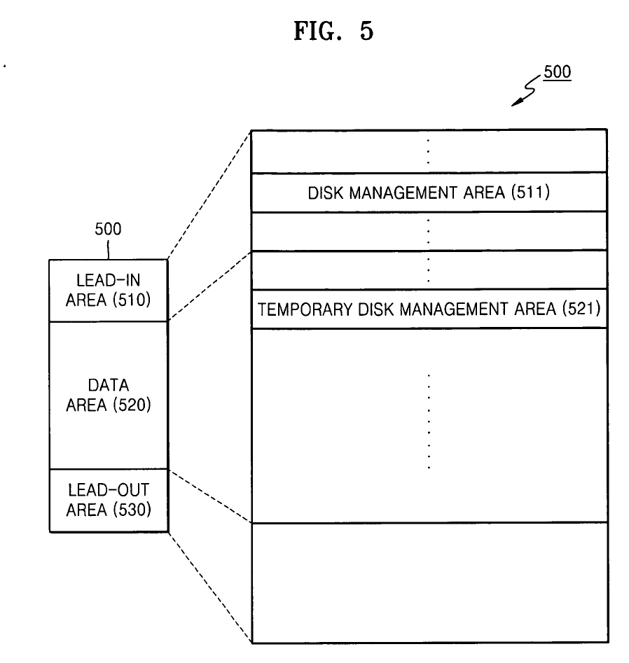

FIG. 5 illustrates an example structure of an information storage medium employing the linking scheme according to an embodiment of the present invention.

Referring to FIG. 5, the structure of data to be recorded on a disk 500 serving as a non-rewritable information recording medium includes a lead-in area 510, a data area 520, and a lead-out area 530.

The lead-in area 510 is an area in which information regarding the disk 500 is written and includes at least a disk management area 511. The final disk management information, including information regarding one or more defects occurring in the data area 520 is recorded in the disk management area 511 when the disk 500 is finalized. Although such a disk management area 511 is provided in the lead-in area 510 as shown in FIG. 5, the disk management area may be provided in the lead-out area 530. In addition, a plurality of disk management areas may also be provided in the lead-in area 510 and/or the lead-out area 530 for the purpose of reliably recording the data.

A temporary disk management area 521 is an area used for temporary defect management for managing the non-rewritable information recording medium and for recording information on the temporary disk management. Such a temporary disk management area 521 may include a temporary defect list (not shown) containing information on temporary defects and including location information of defective data and location information of replacement data for replacing defective data. Specifically, the temporary defect list (not shown) may include a replacement entry (DFL entry) for indicating a state of the replacement by LOW or the replacement by defect.

A data area 520 is an area for recording user data. Such a data area 520 may include one or more spare areas provided to record replacement data and an actual user data area provided to record user data. That is, the user data and LOW-based replacement data for updating the existing user data or replacement data for replacing defective data when defects are generated in the existing user data are written in the data area 520.

Specifically, the data area 520 can also be provided with the temporary disk managing area 521 for storing temporary defect information for management of the replacement by LOW or the replacement by defect. As previously discussed, the temporary defect information includes location information of defective data and location information of replacement data for replacing the defective data.

The replacement entry is written in a format indicating the replacement state of a sector unit according to the present invention. Although the temporary disk managing area 521 is provided in the data area 520 as shown in FIG. 5, the temporary disk managing area 521 may also be provided in the lead-in area 510 or the lead-out area 530.

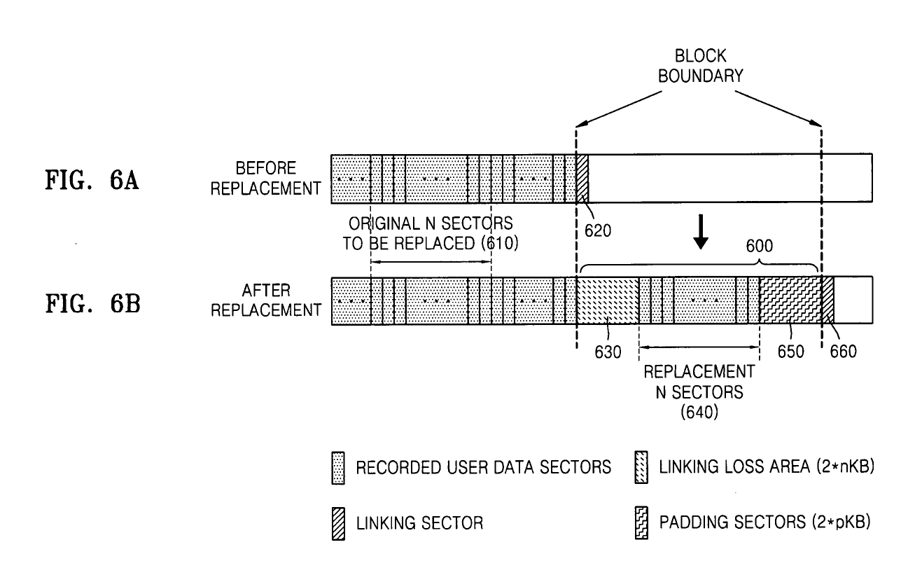

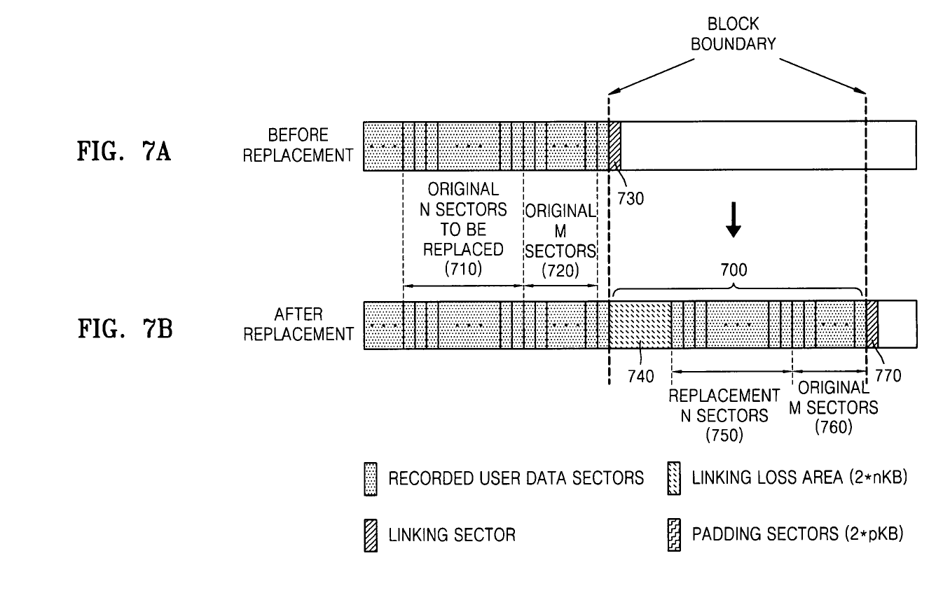

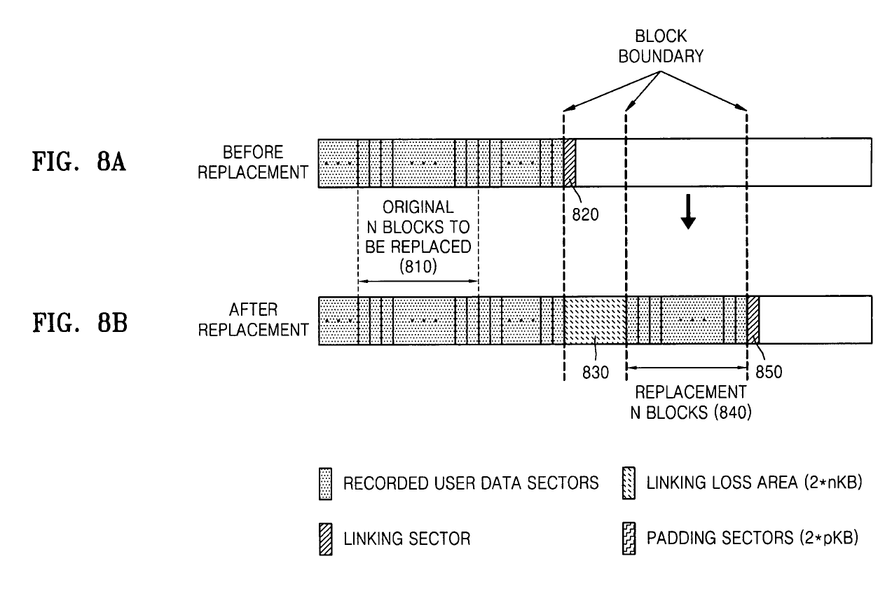

A linking scheme for the replacement by LOW will now be described with reference to FIGS. 6A-6B, 7A-7B and 8A-8B. A linking scheme for the replacement of a sector unit is shown in FIGS. 6A-6B. A linking scheme for the replacement based on Read-Modify-Write is shown in FIGS. 7A-7B; and a linking scheme for the replacement of a block unit is shown in FIGS. 8A-8B.

FIGS. 6A-6B provide an explanatory diagram illustrating an example linking loss area for replacement by LOW according to an embodiment of the present invention. Specifically, FIG. 6A shows the state of recording blocks on an information storage medium before the replacement by LOW, and FIG. 6B shows the state of recording blocks on an information storage medium after the replacement by LOW.

Referring to FIG. 6A, the first sector of a non-written block denotes a linking sector 620. That is, data is recorded in the first several bytes of the first sector of the subsequent block due to the writing of the previous block, and the first sector is referred to as a linking sector 620. When data is recorded successive on the linking sector 620, data is successively recorded after the first several bytes of the linking sector 620.

In FIG. 6B, a replacement recording block 600 for replacing N original sectors 610 to be replaced is recorded. Referring to FIG. 6B, the replacement recording block 600 includes a linking loss area 630 having a size of 2*nKB, a N replacement sector part 640 for replacing the N original sectors 610, and a padding sector part 650 having a size of 2*pKB.

Here, 0<n<16 is satisfied in 2*nKB indicating the size of the linking loss area 630 and 0≦p<16 is satisfied in 2*pKB indicating the size of the padding sector part 650, where n and p are all integers.

It is preferable that n+p+N is the smallest number of multiples of 16, for the following reason. That is, since the unit of record by the drive system is a block in replacing the continuous N original sectors with continuous N replacement sectors, one or more blocks will be recorded for the replacement. At this time, the linking loss area 630 can include at minimum one (1) sector to a maximum of fifteen (15) sectors depending upon the number of replacement sectors and when the sum of the size of the linking loss area 630 and the size of the replacement sectors 640 is not a multiple of the block size, the minimum padding sector (with 00h) should be padded and thus a multiple of the block size should be written so as to be a multiple of the block size. At this time, since the drive system replaces only the sectors to be actually replaced, the replacement entry preferably provides the replacement state of a sector unit, not of a block unit, as shown in FIG. 12.

In this way, by performing the replacement linking in a sector unit, not in a block unit, it is possible to guarantee reliability of data due to the linking scheme and to minimize the loss of usable capacity of the disk due to the linking loss area. In addition, by displaying the replacement state in a sector unit having a number field as shown in FIG. 12, it is possible to correctly display the replacement state.

FIGS. 7A-7B are an explanatory diagram illustrating an example linking loss area for the replacement by LOW according to another embodiment of the present invention. The example shown in FIGS. 7A-7B is similar to the example shown in FIGS. 6A-6B; however, they are different from each other in that sectors not requiring the replacement of data other than sectors requiring to be replaced are replaced together.

Referring to FIG. 7A, N original sectors 710 to be replaced and M original sectors 720 adjacent thereto are shown. A replacement recording block 700 for replacing the original sectors including the M original sectors 720 in addition to the N original sectors 710 to be replaced is shown in FIG. 7B.

Referring to FIG. 7B, the replacement recording block 700 includes a linking loss area 740 having a size of 2*nKB, N replacement sectors 750 for replacing N original sectors 710, and M original sectors 760 for replacing M original sectors 720.

When the unit of Read-Modify-Write is a recording block, the replacement in a block unit shown in FIGS. 8A-8B is performed, but when the unit of Read-Modify-Write is not a recording block, the replacement shown in FIGS. 7A-7B is performed. That is, since the new replacement recording block 600 shown in FIGS. 6A-6B includes only the replaced sectors, it is not necessary to read the original sectors; however, since the new replacement recording block 700 shown in FIGS. 7A-7B further includes the original sectors 760, it is necessary to read the original sectors.

When the host instructs to logically overwrite some sectors of a block in the case of logical overwrite (LOW), the drive system may perform the Read-Modify-Write to replace the block including the sectors in a unit of block and may replace only the sectors without performing the Read-Modify-Write. However, when the replacement entry indicates the replacement in a unit of sector, it is preferable that only the sectors are replaced without performing the Read-Modify-Write. Specifically, it is more preferable that n=1 in the linking loss area of 2*nKB, that is, the linking loss area of 2 KB. The replacement can be more easily performed by applying the fixed linking loss area to the replacement and the use efficiency of a disk can be enhanced by minimizing the size of the linking loss area.

FIGS. 8A-8B are an explanatory diagram illustrating an example linking loss area for the replacement by LOW according to another embodiment of the present invention.

The example shown in FIGS. 8A-8B shows a linking scheme in a case where the replacement would be performed in a unit of block which is a unit of recording/reproduction by the drive system even when an instruction is to replace some sectors, not the whole block.

Referring to FIG. 8A, before the replacement, N original blocks 810 to be replaced is indicated and the linking sector 820 is indicated in the first sync frame of the first block in a non-recorded area.

N replacement blocks 840 with which the N original blocks 810 should be replaced are recorded and the linking loss area 830 having a size of 32 KB is provided to guarantee the data reliability of the replacement blocks. The replacement state in a unit of block can be displayed in the same manner as the SDL entry of DVD-RAM. In this case, as shown in FIG. 12, the replacement entry can be provided in a unit of sector along with the number field.

In addition, the replacement in a unit of block and the replacement in a unit of sector as described above may be mixed. The replacement in a unit of sector shown in FIGS. 6A-6B is useful for the replacement of some sectors, but not the whole block; and the replacement in a unit of block shown in FIGS. 8A-8B is useful for the replacement of the whole block, but not selected sectors.

At the time of reproduction, when receiving an instruction to reproduce N original sectors or some sectors thereof from the host, the drive system should reproduce a block including the replacement sectors for the N original sectors or some sectors thereof from the replacement entry and correct the error of the block. This is because the unit of error correction is not a sector but a block. At this time, as shown in FIG. 6B, the block including the sectors for the linking loss area, the replacement sectors, and the padding sectors (p>1) should be reproduced, but the drive system cannot know which sectors in the block correspond to the linking loss area. Therefore, the sectors corresponding to the linking loss area should be marked in the corresponding block or sectors and the error correction matching with the purpose of the linking loss area should be performed, such that the drive system can know the sectors corresponding to the linking loss area in replacement at the time of reproduction so as to provide the information on the linking loss area. Generally, since the data written in the linking loss area is stored as constant values which the drive system can understand such as “00h”, the drive system can perform the error correction matching with the purpose of the linking loss area by considering the sectors corresponding to the linking loss area as “00h” and performing the error correction. Accordingly, it is possible to prevent the reduction of reliability of the data due to the linking.

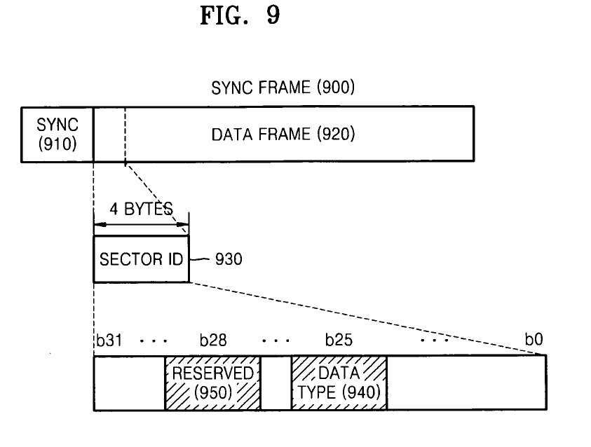

When an error correction format such as DVD-R is used, the information indicating that the sector corresponds to the linking loss area can be marked by setting “1” to a data type bit which is the 25th of the sector ID stored in 4 bytes next to a sync of the first sync frame of each sector. Referring to FIG. 9, each sector includes a plurality of sync frames, and each sync frame 900 includes a sync portion 910 and a data frame 920, where 4 bytes next to the sync portion 910 constitute a field relating to a sector ID 930. Information on the corresponding sector and the sector number is included in the sector ID 930, where the 25^{th} bit of the 4-byte sector ID 930 is set as a data type bit 940 indicating a data type and the 28^{th} bit of the 4-byte sector ID 930 is set as a reserved bit 950. In accordance with embodiments of the present invention, it is possible to display that the corresponding sector is a sector corresponding to the linking loss area, by setting “1” to the 25^{th} bit (reserved bit 940) of the sector ID 930.

However, since the data type bit 940 in the linking sector is set in advance by the previous writing (recording), it is not possible to indicate that the first sector of the recording block for replacement is the linking loss area. Therefore, when the linking loss area includes sectors of which the number is equal to or greater than 2 and smaller than 16, it is preferable that the drive system marks, by using the 25^{th} bit (data type bit 940) of the sector ID 930, the information that the second sector to the final sector in the linking loss area belong the linking loss area. Since the information indicating the linking loss area cannot be marked in the first sector (that is, a linking sector at the time of the previous writing, a linking loss area) of the recording block for replacement, it is preferable that such information is written in the first block at the time of replacement or in the replacement entry. In writing such information in the first block, it is preferable that the previous sector, that is, the first sector, belongs to the linking loss area by setting “1” to the 28^{th} bit (reserved bit 950) of the sector ID 930 in the second sector of the first block at the time of replacement. This is true at the time point of additively writing data due to the linking loss area, as well as the time point of replacement. In the replacement entry, by setting “1” to a predetermined flag, it is possible to mark that the first sector of the first block including the replacement sectors of the replacement entry belongs to the linking loss area. However, since the linking loss area can be marked in a predetermined bit of the sector ID, the present invention is not limited to the case where only the 25^{th} bit (data type bit 940) and the 28^{th} bit (reserved bit 950) of the sector ID 930 are used. Rather, other bit within the sector ID 930 can also be contemplated for marking purposes.

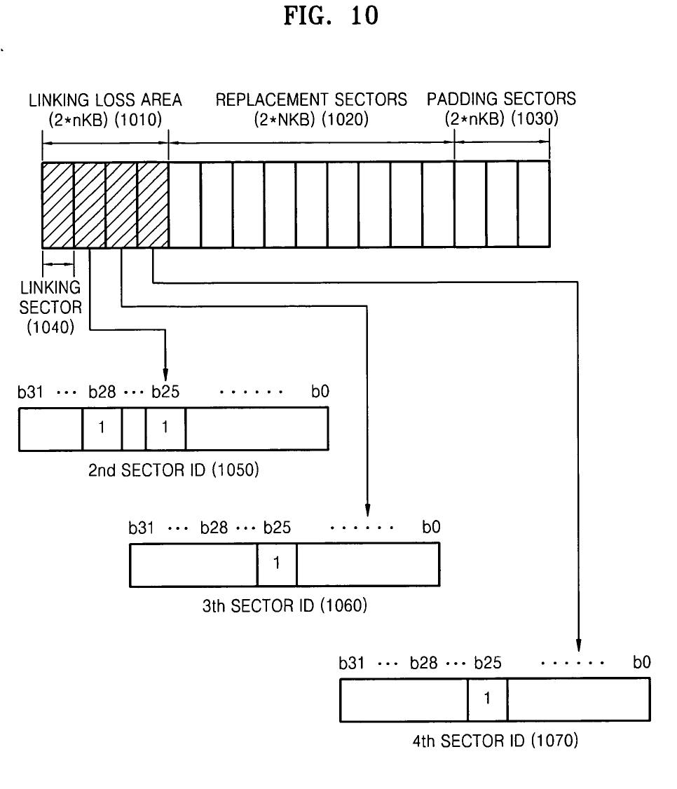

Turning now to FIG. 10, an explanatory diagram of an example linking loss area having a size of 2*nKB according to an embodiment of the present invention is illustrated. As shown in FIG. 10, a replacement recording block includes a linking loss area 1010 of four (4) sectors, nine (9) replacement sectors 1020, and three (3) padding sectors 1030.

The first sector 1040 of the linking loss area 1010 is a linking sector written by the previous writing and corresponds to the linking loss area. In the second to fourth sectors of the linking loss area 1010, by setting “1” to the 25^{th} bit of each sector ID, that is, the second sector ID 1050, the third sector ID 1060, and the fourth sector ID 1070, it can be marked that the corresponding sector belongs to the linking loss area. However, since data is recorded in the linking sector which is the first sector at the previous recording operation, the 25^{th} bit of the sector ID cannot be set as intended. Accordingly, such marking is performed to the second sector. That is, by setting “1” to the reserved bit of the 28^{th} bit in the sector ID 1050 of the second sector, it is possible to indicate that the previous sector belongs to the linking loss area.

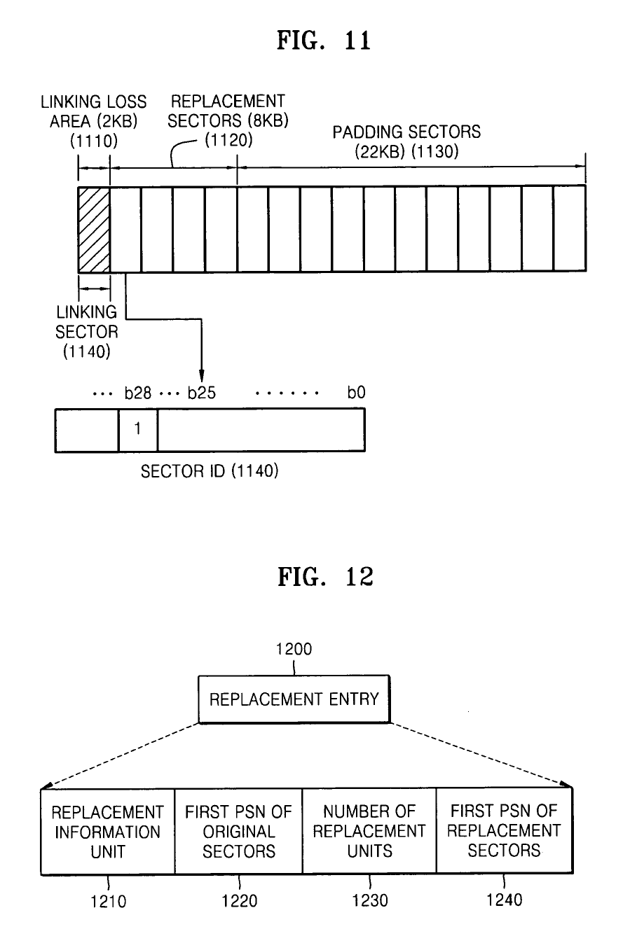

FIG. 11 is an explanatory diagram illustrating an example linking loss area having a size of 2 KB according to an embodiment of the present invention.

The example shown in FIG. 11 illustrates the case where the linking loss area 1110 has 2 KB that corresponds to a sector. In this case, the sector belonging to the linking loss area is the linking sector itself. By setting “1” to the 28^{th} bit of the sector ID 1140 in the sector next to the linking sector, that is, the first sector of the replacement sectors, it is possible to indicate that the previous sector belongs to the linking loss area.

FIG. 12 is a format of an example replacement entry which can effectively mark the replacement employing the linking scheme according to an embodiment of the present invention.

Referring to FIG. 12, the replacement entry 1200 includes replacement unit information 1210, a first physical sector number (PSN) of the original sector 1220, the number of replacement units 1230, and a first PSN of the replacement sector 1240.

The replacement unit information 1210 indicates the replacement unit included in the replacement entry 1200 and indicates whether the replacement is performed in a unit of sector or in a unit of block.

The first PSN of the original sector 1220 indicates an address (physical sector number) of the first sector in the continuous original sectors to be replaced. However, the first PSN of the original sectors 1220 is not limited to the first sector in the continuous original sectors. Rather, any sector in the continuous original sectors may be utilized. For example, the first PSN of the original sector 1220 indicates an address of the final sector in the continuous original sectors.

The number of replacement units 1230 indicates the number of replacement units continuously replaced. Specifically, when the replacement unit is a sector, the number of sectors continuously replaced may be indicated. In addition, when the replacement unit is a block, the number of blocks continuously replaced may be indicated.

The first PSN of the replacement sectors 1240 indicates an address (physical sector number) of the first sector in the continuous replacement sectors. The first PSN of the replacement sector 1240 is not limited to the first sector in the continuous replacement sectors. Rather, any sector in the continuous replacement sectors may be utilized. For example, the first PSN of the replacement sectors 1240 indicates an address of the final sector in the continuous replacement sectors.

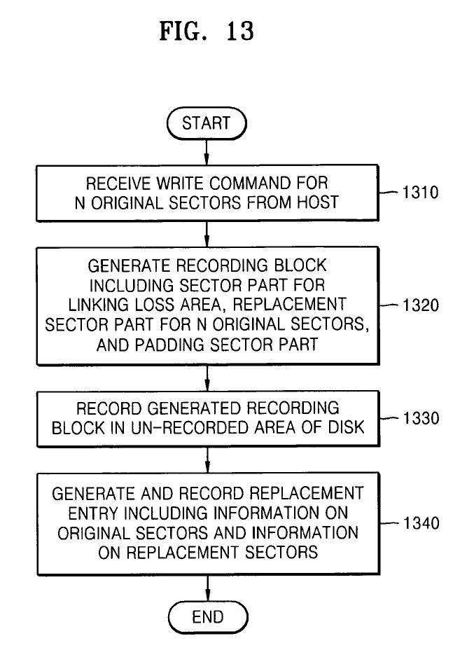

FIG. 13 is a flowchart illustrating an example recording method according to an embodiment of the present invention.

Referring to FIG. 13, the drive system receives a write command on the N original sectors from the host at block 1310.

When performing the replacement in a unit of sector, the drive system generates the N replacement sectors for replacing the N original sectors and the replacement recording block including the sector part for the linking loss area and the padding sector part at block 1320. Of course, the drive system may perform the replacement in a unit of block in addition to the replacement in a unit of sector or may perform the replacement through Read-Modify-Write. When the sectors to be replaced excess the size of one block in the replacement in a unit of sector, the drive system generates a plurality of replacement recording blocks. In the sectors of the linking loss area, as described with reference to FIGS. 9 to 11, the 25^{th} bit and the 28^{th} bit of the sector ID can be set to “1” in order to indicate that the sectors belong to the linking loss area.

Then, the drive system records the generated recording block in a non-recorded area of the disk 500 at block 1330.

Next, the drive system generates and records the replacement entry including the information on the original sectors and the information on the replacement sectors at block 1340. The replacement entry for the replacement in a unit of sector has been described with reference to FIG. 12.

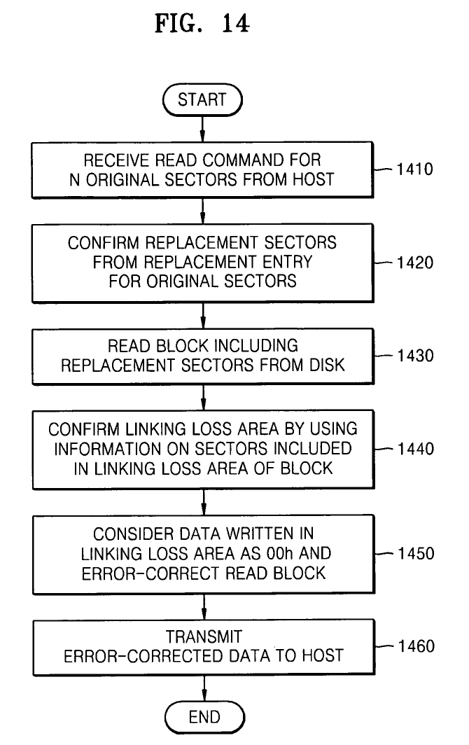

FIG. 14 is a flowchart illustrating an example reproducing method according to an embodiment of the present invention.

Referring to FIG. 14, the drive system receives a read command for the N original sectors from the host at block 1410.

Then, the drive system confirms the locations of the replacement sectors from the replacement entry for the original sectors at block 1420.

Next, the drive system reads the block including the replacement sectors from the disk 500 at block 1430.

Next, the drive system confirms the linking loss area included in the read block by using the sector information at block 1440. That is, when “1” is set to the 25^{th} bit of the sector ID, it means that the corresponding sector belongs to the linking loss area, and when “1” is set to the 28^{th} bit of the sector ID, it means that the linking sector belongs to the linking loss area.

When confirming the linking loss area, the drive system considers the data written in the linking loss area as “00h” and corrects the error of the read block at block 1450.

The drive system then transmits the error-corrected data to the host at block 1460.

As described in various embodiments of the present invention, it is possible to minimize the loss of user data capacity which can be used for actual replacement in a unit of sector in a linking action by replacement by LOW or replacement by defect. In addition, it is possible to confirm a linking loss area by using information indicating the linking loss area, thereby enhancing the reliability in reproducing data.

Various aspects and embodiments of the present invention can be written as computer programs and can be implemented in general-use digital computers that execute the programs using a computer readable recording medium. Examples of the computer readable medium include magnetic storage media (e.g., ROM, floppy disks, hard disks, etc.), optical recording media (e.g., CD-ROMs, DVDs, etc.), and storage media such as carrier waves (e.g., transmission through the Internet). The computer readable medium can also be distributed over network coupled computer systems so that the computer readable code is stored and executed in a distributed fashion. In addition, functional programs, codes and code segments for accomplishing the recording/reproducing methods according to the present invention may be easily deducted by programmers in the art which the present invention pertains.

While there have been illustrated and described what are considered to be example embodiments of the present invention, it will be understood by those skilled in the art that various changes in form and modification may be made therein, and equivalents may be substituted for elements thereof without departing from the spirit and scope of the present invention. For example, different size of a linking loss area may be implemented and different bits within the sector ID can be utilized as long as the linking loss area is minimized within a recording block, and data replacement techniques as described in connection with FIG. 3, FIG. 4, FIGS. 6A-6B, FIGS. 7A-7B, FIGS. 8A-8B, FIG. 9, FIG. 10, FIG. 11, FIG. 12, FIG. 13, and FIG. 14 are utilized. Likewise, a central controller can be implemented as a chipset, or alternatively, a general or special purposed computer programmed to perform the methods as described with reference to FIGS. 13-14. Accordingly, it is intended, therefore, that that present invention not be limited to the various example embodiments disclosed, but that the present invention includes all embodiments falling within the scope of the appended claims.

What is claimed is:

1. An information recording medium, comprising:
a data area provided to record data in recording blocks, wherein a linking loss area having a unit smaller than a unit of a recording block and having a predetermined size is disposed in a recording block used for replacement by logical overwrite for updating data recorded in the data area or replacement by defects occurred in the data area.

2. The information recording medium according to claim 1, wherein the unit smaller than the unit of block is a sector.

3. The information recording medium according to claim 1, wherein the predetermined size is N sectors, where N is an integer greater than zero (0) and smaller than sixteen (16).

4. The information recording medium according to claim 1, wherein information indicating the linking loss area is recorded in the recording block.

5. The information recording medium according to claim 2, wherein the recording block includes a plurality of sectors, and information indicating that a first sector of the recording block is the linking loss area is recorded in the recording block or in a replacement entry containing information on the replacement.

6. The information recording medium according to claim 5, wherein, when the information indicating the linking loss area is recorded in the recording block, the information is written in a sector ID field of a second sector of the recording block.

7. A recording apparatus for recording data on an information recording medium, comprising:
a write/read unit which writes data on the recording medium or reads data from the recording medium; and
a control unit which disposes a linking loss area having a unit smaller than a unit of a recording block and having a predetermined size in the recording block used for replacement by logical overwrite (LOW) to update data recorded on the recording medium or replacement by defects occurred on the recording medium, and which controls the write/read unit to write the recording block on the recording medium.

8. The recording apparatus according to claim 7, wherein the unit smaller than the unit of block is a sector.

9. The recording apparatus according to claim 7, wherein the predetermined size is N sectors, where N is an integer greater than zero (0) and smaller than sixteen (16).

10. The recording apparatus according to claim 7, wherein the control unit records information indicating the linking loss area in the recording block.

11. The recording apparatus according to claim 8, wherein the recording blocks includes a plurality of sectors, and the control unit records information indicating that a first sector of the recording block belongs to the linking loss area in the recording block or in a replacement entry containing information on the replacement.

12. The recording apparatus according to claim 11, wherein, when the information indicating the linking loss area is recorded in the recording block, the information is written in a sector ID field of a second sector of the recording block.

13. A reproducing apparatus for reproducing data from an information recording medium, comprising:
a write/read unit which writes data in the recording medium or reads data from the recording medium; and
a control unit which controls the write/read unit to read from the recording medium a recording block in which a linking loss area having a unit smaller than a unit of a recording block and having a predetermined size is disposed,
wherein the recording block is used for data replacement for the purpose of replacement by logical overwrite (LOW) to update data recorded on the recording medium or replacement by defects occurred on the recording medium.

14. The reproducing apparatus according to claim 13, wherein the unit smaller than the unit of block is a sector.

15. The reproducing apparatus according to claim 13, wherein the predetermined size is N sectors, where N is an integer greater than zero (0) and smaller than sixteen (16).

16. The reproducing apparatus according to claim 13, wherein the control unit extracts information indicating the linking loss area from the recording block.

17. The reproducing apparatus according to claim 14, wherein the recording block includes a plurality of sectors, and the control unit extracts information indicating that a first sector of the recording block belongs to the linking loss area from the recording block or from a replacement entry containing information on the replacement.

18. The reproducing apparatus according to claim 11, wherein, when the information indicating the linking loss area is extracted from the recording block, the information is extracted from a sector ID field of a second sector of the recording block.

19. The reproducing apparatus according to claim 16, wherein the control unit performs error correction of the recording block in accordance with determination whether the first sector of the recording block is the linking loss area.

20. A recording method of recording data in an information recording medium, comprising:
disposing a linking loss area having a unit smaller than a unit of a recording block and having a predetermined size in the recording block used for data replacement for the purpose of replacement by logical overwrite (LOW) to update data recorded in the recording medium or replacement by defects occurred on the recording medium; and
recording the recording block on the recording medium.

21. The recording method according to claim 20, wherein the unit smaller than the unit of block is a sector.

22. The recording method according to claim 20, wherein the predetermined size is N sectors, where N is an integer greater than zero (0) and smaller than sixteen (16).

23. The recording method according to claim 20, wherein the disposing a linking loss area includes:
recording information indicating the linking loss area in the recording block.

24. The recording method according to claim 21, wherein the disposing a linking loss area further includes:
recording information indicating that a first sector of the recording block belongs to the linking loss area in the recording block or recording information indicating that a first sector of the recording block belongs to the linking loss area in the recording block in a replacement entry containing information on the replacement.

25. The recording method according to claim 24, wherein, when the information indicating the linking loss area is recorded in the recording block, the information is written in a sector ID field of a second sector of the recording block.

26. A reproducing method for reproducing data from an information recording medium, comprising:
reading, from the recording medium, a recording block in which a linking loss area having a unit smaller than a unit of the recording block and having a predetermined size is disposed, wherein the recording block is recorded for data replacement for the purpose of replacement by logical overwrite to update data recorded on the recording medium or replacement by defects occurred on the recording medium; and
reproducing the read recording block.

27. The reproducing method according to claim 26, wherein the unit smaller than the unit of block is a sector.

28. The reproducing method according to claim 26, wherein the predetermined size is N sectors, where N is an integer greater than zero (0) and smaller than sixteen (16).

29. The reproducing method according to claim 26, wherein the reproducing the read recording block includes:
extracting information indicating the linking loss area from the recording block.

30. The reproducing method according to claim 27, wherein the reproducing the read recording block further includes:
extracting information indicating that a first sector of the recording block belongs to the linking loss area from the recording block or extracting information indicating that a first sector of the recording block belongs to the linking loss area from a replacement entry containing information on the replacement.

31. The reproducing method according to claim 31, wherein, when the information indicating the linking loss area is extracted from the recording block, the information is extracted from a sector ID field of a second sector of the recording block.

32. The reproducing method according to claim 29, wherein the reproducing the read recording block further includes
performing error correction of the recording block depending on whether the first sector of the recording block is the linking loss area.

33. An information storage medium comprising:
a data area for recording data in blocks; and
a linking loss area having a predetermined size disposed in a recording block used for data replacement by logical overwrite (LOW) to update data recorded in the data area;
wherein a replacement entry recorded in the data area includes information indicating whether data replacement is performed by units of blocks or units of sectors within each block, information on original sectors within each block to be replaced, and information on replacement sectors to replace the original sectors.

34. The information storage medium according to claim 33, wherein the recording block used for data replacement includes a plurality of sectors, and information indicating that a first sector of the recording block is the linking loss area is recorded in the recording block or in the replacement entry containing information on the replacement.

35. The information storage medium according to claim 33, wherein, when the information indicating the linking loss area is recorded in the recording block, the information is written in a sector ID field of a second sector of the recording block.
